(19) United States
(12) Patent Application Publication
(10) Pub. No.: US 2003/0048241 A1
(43) Pub. Date: Mar. 13, 2003

(54) Method of driving capillary discharge plasma display panel for improving power efficiency

(75) Inventors: Bhum Jae Shin, Rutherford, NJ (US); Dong Woo Yu, Demarest, NJ (US); Steven Kim, Harrington Park, NJ (US); Michael D. Martin, West New York, NJ (US); William Kokonaski, Gig Harbor, WA (US)

Correspondence Address: MORGAN LEWIS & BOCKIUS LLP, 1111 PENNSYLVANIA AVENUE NW, WASHINGTON, DC, 20004, US

(73) Assignee: Plasmion Displays, LLC

(21) Appl. No.: 09/949,982

(22) Filed: Sep. 12, 2001

(51) Int. Cl. G09G 3/28

(52) U.S. Cl. 345/60

(57) ABSTRACT

In a method of driving a capillary discharge plasma display panel which comprises front and rear substrates forming a space discharge therein, an addressing electrode on the front substrate, a common electrode and a plurality of scanning electrodes on the rear substrate, and a dielectric layer covering the common electrode and the scanning electrodes and having a capillary corresponding to the common electrode and each scanning electrode in the second dielectric layer, the method includes the steps of applying an addressing pulse to the addressing electrode and a first pulse to the common electrode, and a second pulse sequentially from a 1^{st} scanning electrode to an n^{th} scanning electrode during an addressing period for selecting pixels to be turned on, and applying a first sustaining pulse to the common electrode and a second sustaining pulse to the 1^{st} scanning electrode to the n^{th} scanning electrode during a sustaining period, wherein the first and second sustaining pulses are applied for only discharge time duration.

### BACKGROUND OF THE INVENTION

1. Field of the Invention

The present invention relates to a plasma display panel, and more particularly, to a method of driving capillary discharge plasma display panel for improving power efficiency. Although the present invention is suitable for a wide scope of applications, it is particularly suitable for reducing power consumption in the capillary discharge plasma display panel.

2. Discussion of the Related Art

Plasma display panels (PDPs) generally have been classified into three types: an AC type discharge display device, a DC type discharge display device, and an AC-DC hybrid type discharge display device. The AC type has a pair of discharge electrodes that are opposite to each other and both electrodes are covered by a dielectric layer. The DC type has a pair of electrodes and both electrodes are exposed to a discharge space. In the hybrid type, one discharge electrode of a pair of electrodes is covered with a dielectric layer and another discharge electrode is exposed to a discharge space.

As a new type discharge display device, a capillary discharge type plasma display panel has been proposed in U.S. Pat. No. 6,255,777. Unlike the above-explained types, the capillary discharge type PDP provides a capillary discharge site in a dielectric layer on one of the discharge electrodes. Thus, the capillary discharge PDP demonstrated high brightness comparing to the conventional type PDPs.

In PDPs, brightness is controlled by the number of discharge pulses. Generally, the maximum number of discharges per field is about 2,500 that generate brightness of about 700 cd/m². However, power consumption is more than a thousand watts in the conventional 42-inch PDPS. Thus, an automatic power control (APC) method has been used in the conventional type PDPs to reduce power consumption. However, the APC method often results in poor Brightness in the conventional glow discharge.

On the other hand, the capillary discharge type generates high brightness as explained above. A current profile of the capillary discharge PDP is different from that of the conventional PDPs due to its unique discharge characteristic.

Generally, the width of sustaining pulses applied to the conventional type PDPs is normally for about 2.5 to 3 μsec. However, in the case of capillary discharge, a current tail tends to occur at the later part of the sustaining pulse if such a pulse is applied to the capillary discharge type PDP. This causes a circuit loss. Therefore, the capillary discharge type PDP has a problem in power efficiency yet to be improved.

### SUMMARY OF THE INVENTION

Accordingly, the present invention is directed to a method of driving a capillary discharge plasma display panel for improving power efficiency that substantially obviates one or more of problems due to limitations and disadvantages of the related art.

Another object of the present invention is to provide a method of driving a capillary discharge plasma display panel that provides an optimum condition for operating the capillary discharge plasma display panel.

Additional features and advantages of the invention will be set forth in the description that follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in a method of driving a capillary discharge plasma display panel which comprises front and rear substrates forming a space discharge therein, an addressing electrode on the front substrate, a common electrode and a plurality of scanning electrodes on the rear substrate, and a dielectric layer covering the common electrode and the scanning electrodes and having a capillary corresponding to the common electrode and each scanning electrode in the second dielectric layer, the method includes the steps of applying an addressing pulse to the addressing electrode and a first pulse to the common electrode, and a second pulse sequentially from a 1^{st} scanning electrode to an n^{th} scanning electrode during an addressing period for selecting pixels to be turned on, and applying a first sustaining pulse to the common electrode and a second sustaining pulse to the 1^{st} scanning electrode to the n^{th} scanning electrode during a sustaining period, wherein the first and second sustaining pulses are applied for only discharge time duration. (Typically less than 2 usec) The discharge time duration is dependent on various parameters such as geometry, gas composition, and pressure etc.. However once we figure out the characteristics of discharge time duration, the width of applied pulse is optimized to provide adequate discharge, but is short enough to eliminate or reduce the current losses occurring after discharge.

In another aspect of the present invention, in a method of driving a capillary discharge plasma display panel which comprises front and rear substrates forming a space discharge therein and facing into each other, a data electrode on the front substrate, a plurality of first and second row electrodes on the rear substrate, and a dielectric layer covering the first and second row electrodes and having a capillary corresponding to each first and second row electrodes in the second dielectric layer, the method includes the steps of applying a first reset pulse to X electrodes, a second reset pulse to Y electrodes, and a third reset pulse to X electrodes, the first, second and third reset pulses not superposing one another; applying an addressing pulse to the addressing electrode and a constant pulse to the first row electrode, and a scanning pulse sequentially from a 1^{th} second row electrode to an n^{th} second row electrode during an addressing period for selecting pixels to be turned on; and applying a first sustaining pulse to the first row electrode and a second sustaining pulse to the 1^{st} second row electrode to the n^{th} second row electrode during a sustaining period, wherein the first and second sustaining pulses are applied for only discharge time duration.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a schematic cross-section view of a capillary discharge plasma display panel according to the present invention;

FIG. 2 is time charts illustrating driving scheme for driving the capillary discharge plasma display panel according to the present invention; and

FIG. 3 is a diagram for a sustaining pulse and a current profile for the capillary discharge plasma display panel according to the present invention; and

FIGS. 4A and 4B are schematic diagrams for two different sustaining pulses having different pulse widths according to the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

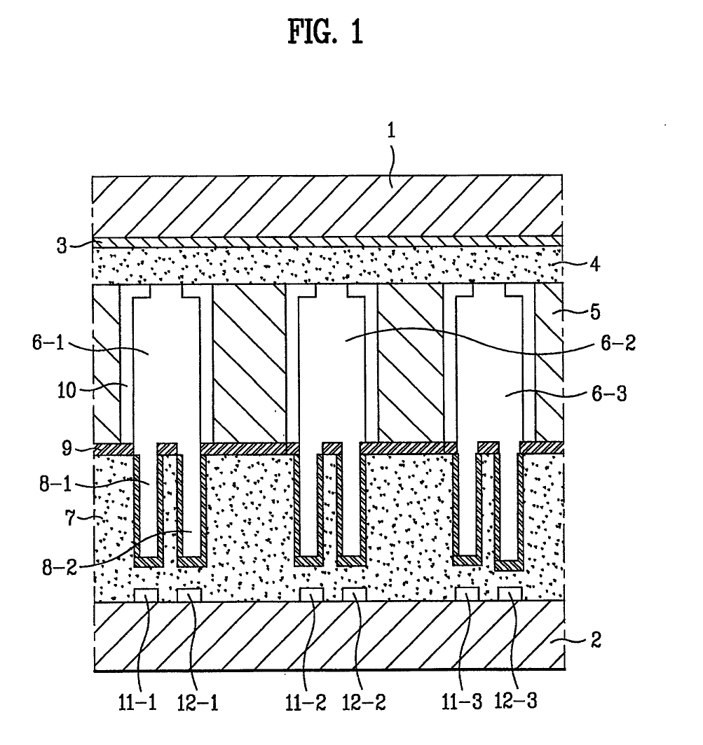

FIG. 1 illustrates a capillary discharge plasma display panel (CDPDP) according to the present invention. The CDPDP comprises a pair of front and rear glass substrates 1 and 2 disposed opposite to each other, interposing a plurality of discharge spaces 6-1, 6-2, and 6-3 therebetween. The glass front substrate 1 as a display portion has an address electrode 3. A first dielectric layer 4 covers the address electrode 3 for generating wall charges.

On the rear glass substrate 2, X and Y row electrodes 11-1 and 12-1 . . . 11-n and 12-n in pairs are disposed thereon. X row electrode 11-1 may be referred to as a sustaining electrode because it only plays a role in generating sustaining discharge during the sustaining period. On the contrary, Y row electrode may be referred to as a scanning electrode because they are sequentially applied with a scanning pulse to generate the address discharge in the addressing period in addition to the sustaining period. A second dielectric layer 7 is formed on the rear glass substrate 2 including X and Y row electrodes. For capillary discharge, pair of capillaries 8-1 and 8-2 is formed in the second dielectric layer 7. A protection layer 9 such as MgO is coated on the second dielectric layer 7 including inside the capillaries 8-1 and 8-2 for protecting from ion bombardments as well as serving as a secondary electron emission source.

Pluralities of barrier ribs 5 are provided for defining the discharge spaces 6-1, 6-2, and 6-3. The barrier ribs 5 extend to the direction to the addressing electrode and perpendicular to the X and Y electrodes. A phosphor layer 10 having a R, G, or B phosphor covers each inside portion of the barrier ribs 5.

The discharge spaces 6-1, 6-2, and 6-3 are filled with rare gases. Thus, a plurality of pixels including discharge spaces display images on the PDP.

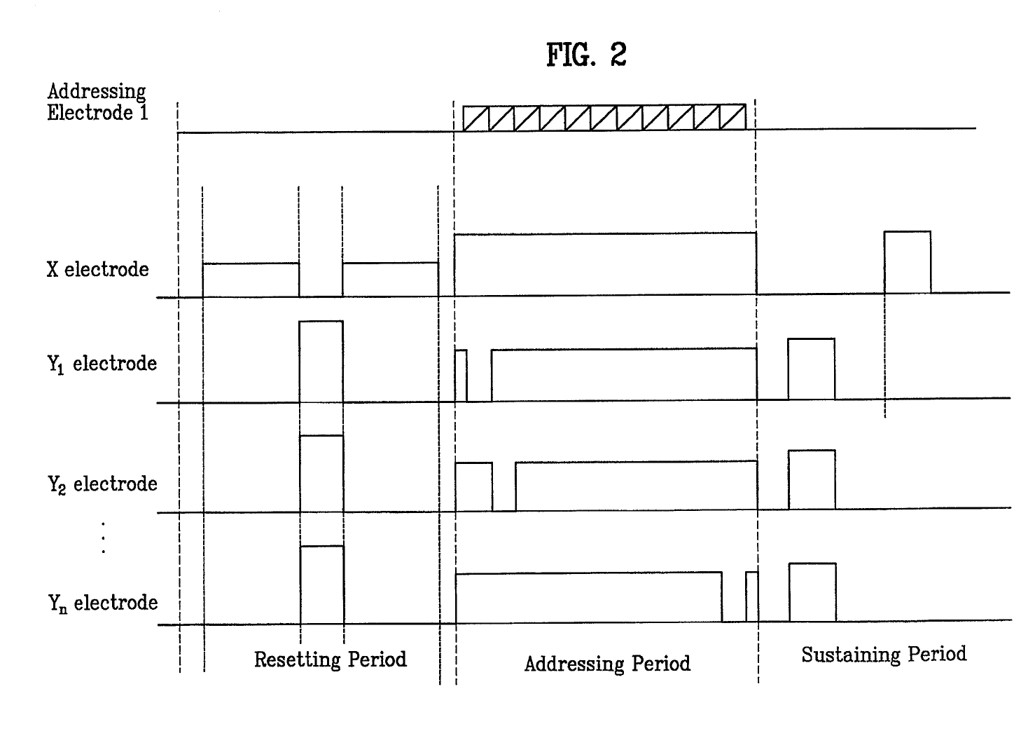

Operation of the PDP will be described as follows. FIG. 2 illustrates a timing chart of driving scheme for driving the PDP by an address display separation (ADS) method.

As shown in FIG. 2, the ADS method comprises three different modes: reset mode, addressing mode, and sustaining mode. In the reset mode, all pixels should become the same condition. Different waveforms, such as wide-low voltage, self-erasing, and ramp pulses, may be applied as a reset pulse. Any one of the pulses may be applied to the capillary discharge plasma display panel of the present invention.

All discharge activity will become a certain minimum level in the reset mode, thereby priming the gas discharge. Priming enhances avalanches of the gas discharge by providing seed electrons. Thus, a reset pulse creates a low-level ionization that is necessary to achieve reliable priming. In addition, the reset pulse is to make the off-state wall voltage to be the precise level, thereby occurring a writing operation in a reliable fashion.

In the reset period, a discharge is initiated but charge transfer is only enough to cancel the charges stored during the previous discharge. In the present invention, the common electrodes (X row electrode) 11-1 to 11-n are applied with about 180 V as a common voltage for about 20 μsec. Scanning electrodes 12-1 to 12-n are simultaneously applied with about 320 V for about 10 μsec. Thereafter, another reset pulse having the same pulse width and height as the previous reset pulse applied to the common electrode is reapplied to the common electrode.

About 2 to 3 μsec later after completion of the reset period, pixels are selectively turned on in the addressing period, so that the images are displayed thereon. Generally, addressing discharge is generated between the addressing electrode and the scanning electrodes. Once the pixel is turned on by the addressing pulse, priming particles and wall charges are generated. Thus, the pixel is discharged by the sustaining pulse in the sustaining period. For implementing a gray scale, the sub-field method is generally used in PDP.

In the present invention, the common electrodes (shown as the reference numerals 11-1 to 11-n in FIG. 1) are applied by a constant pulse, whereas the scanning electrodes (shown as the reference numerals 12-1 to 12-n in FIG. 1) are sequentially applied with a scanning pulse for about 3 μsec, as shown in FIG. 2. The constant scanning pulse has a height of about 200 V while the scanning pulse has a height in the range of about 90 and 120 V. During the addressing period, the addressing pulse having a height in the range of 90 to 120 V is continuously applied to the addressing electrode.

In the sustaining mode, a height of the sustaining pulse is determined as a value between the minimum firing voltage and the maximum sustaining voltage. Thus, if the pixel has wall charges, it can generate sustaining discharge with the sustaining voltage. On the other hand, if the pixel does not have wall charges, it can not generate sustaining discharge with the sustaining voltage. Brightness can be controlled by the number of discharge pulses. Generally, the maximum number of discharges per field is about 2,500 that generates brightness of about 700 cd/m² in the case of 42-inch conventional PDPS. However, such a case, power consumption is more than a thousand watts. Thus, the automatic power control (APC) method is used in most PDPs to reduce power consumption. However, the APC method often results in poor brightness in the conventional glow discharge.

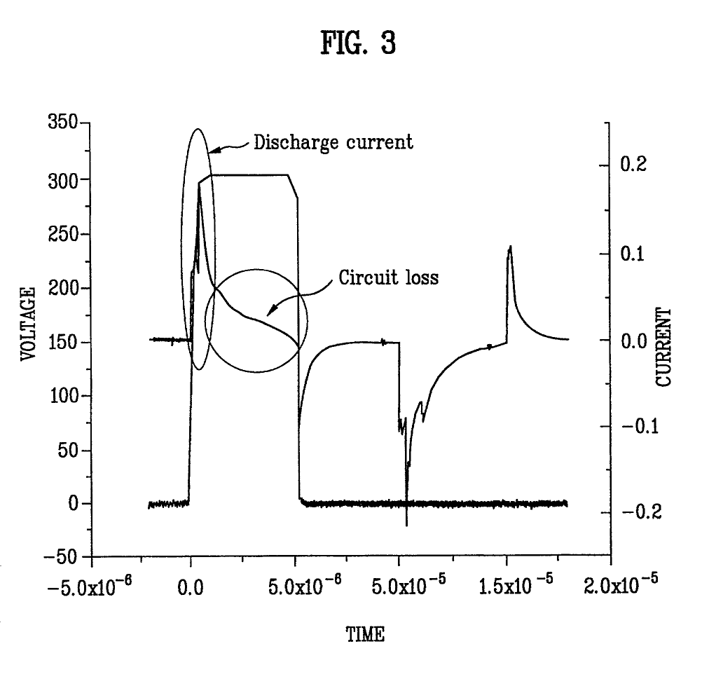

On the other hand, the capillary discharge PDP in the present invention demonstrates good luminance efficiency, so that it generates high brightness without using the APC method or like. The current profile of the capillary discharge PDP is different from that of the conventional PDPs, as shown in FIG. 3. At the later part of the pulse, a current tail begins to occur which cause a circuit loss.

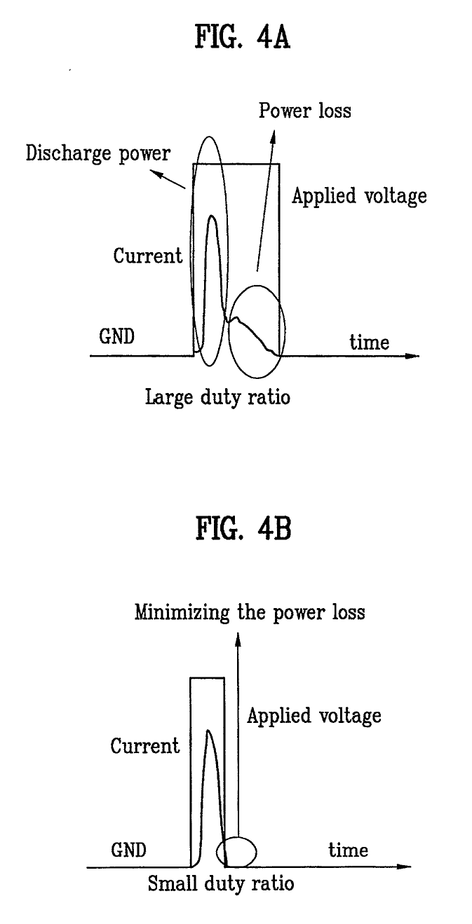

In the present invention, in order to reduce any circuit loss, as shown in FIGS. 4A and 4B, the sustaining pulse is applied to the scanning electrodes for only discharge time duration. Also, the sustaining pulse has a frequency in the range of 10 to 250 kHz. Preferably, the sustaining pulse is applied for about 1.5 μsec at the frequency of about 50 kHz. The sustaining pulse has a height in the range of 180 and 250 V. Also, there is a time interval between the sustaining pulses applied to the common electrodes and the scanning electrodes. For example, the time interval is about 1 to 2 μsec to avoid a short-circuit.

As discussed above, by applying a sustaining pulse for a reduced period of time to avoid a circuit loss, as shown in FIGS. 4A and 4B, the present invention maximizes power efficiency in driving a capillary discharge plasma display panel.

It will be apparent to those skilled in the art that various modifications and variations can be made in the method of driving a capillary discharge plasma display panel for improving power efficiency of the present invention without departing from the spirit or scope of the inventions. Thus, it is intended that the present invention covers the modifications and variations of this invention provided they come within the scope of the appended claims and their equivalents.

What is claimed is:

1. A method of driving a capillary discharge plasma display panel which comprises front and rear substrates forming a space discharge therein, an addressing electrode on the front substrate, a plurality of common electrodes and scanning electrodes on the rear substrate, and a dielectric layer covering the common electrodes and the scanning electrodes and having a plurality of capillaries in the second dielectric layer and each capillary corresponding to the common electrode and each scanning electrode, the method comprising the steps of:
applying an addressing pulse to the addressing electrode and a first scanning pulse to the common electrodes, and a second scanning pulse sequentially from a 1^{st} scanning electrode to an n^{th} scanning electrode during an addressing period for selecting pixels to be turned on; and
applying a first sustaining pulse to the common electrode and a second sustaining pulse to the 1^{st} scanning electrode to the n^{th} scanning electrode during a sustaining period, wherein the first and second sustaining pulses are applied for only discharge time duration.

2. The method according to claim 1, further comprising the step of providing a reset period for erasing wall charges in all pixels.

3. The method according to claim 2, wherein the step of providing a reset period includes the steps of:
applying a first reset pulse to the common electrodes;
applying a second reset pulse to all the scanning electrodes; and
applying a third reset pulse to the common electrodes, wherein the first, second, and third erasing pulses do not superpose one another.

4. The method according to claim 3, wherein the addressing period follows the reset period.

5. The method according to claim 3, wherein the second has a height greater than the first and third reset pulses.

6. The method according to claim 3, wherein the reset period and the addressing period are separated by about 2 to 3 μsec.

7. The method according to claim 1, wherein the sustaining period follows the addressing period.

8. The method according to claim 1, wherein the sustaining period and the addressing period are separated by about 2 to 3 μsec.

9. The method according to claim 1, wherein the first scanning pulse is constantly applied to the common electrodes throughout the addressing period.

10. The method according to claim 1, wherein the second scanning pulse has a width of about 3 μsec.

11. The method according to claim 1, wherein the first and second scanning pulses are separated enough not to occur a short-circuit.

12. The method according to claim 1, wherein the first and second scanning pulses have substantially the same height and width.

13. The method according to claim 1, wherein the first and second scanning pulses have a frequency in the range of about 10 and 250 kHz.

14. A method of driving a capillary discharge plasma display panel which comprises front and rear substrates forming a space discharge therein and facing into each other, a address electrode on the front substrate, a plurality of first and second row electrodes on the rear substrate, and a dielectric layer covering the first and second row electrodes and having a capillary corresponding to each first and second row electrodes in the second dielectric layer, the method comprising the steps of:
applying a first reset pulse to the first row electrode, a second reset pulse to all the second row electrodes, and s third reset pulse to the first row electrode, the first, second and third reset pulses not superposing one another;
applying an addressing pulse to the addressing electrode and a constant pulse to the first row electrode, and a scanning pulse sequentially from a 1^{st} second row electrode to an n^{th} second row electrode during an addressing period for selecting pixels to be turned on; and
applying a first sustaining pulse to the first row electrode and a second sustaining pulse to the 1^{st} second row electrode to the n^{th} second row electrode during a sustaining period, wherein the first and second sustaining pulses are applied for only discharge time duration.

15. The method according to claim 14, wherein the addressing period follows the reset period.

16. The method according to claim 14, wherein the second has a height greater than the first and third reset pulses.

17. The method according to claim 14, wherein the reset period and the addressing period are separated by about 2 to 3 μsec.

18. The method according to claim 14, wherein the sustaining period follows the addressing period.

19. The method according to claim 14, wherein the sustaining period and the addressing period are separated by about 2 to 3 μsec.

20. The method according to claim 14, wherein the first scanning pulse is constantly applied to the common electrodes throughout the addressing period.

21. The method according to claim 14, wherein the second scanning pulse has a width of about 3 μsec.

22. The method according to claim 14, wherein the first and second scanning pulses are separated enough not to occur a short-circuit.

23. The method according to claim 14, wherein the first and second scanning pulses have substantially the same height and width.

24. The method according to claim 14, wherein the first and second scanning pulses have a frequency in the range of about 10 and 250 kHz.
